(19) United States
(12) Patent Application Publication
(10) Pub. No.: US 2010/0116058 A1
(43) Pub. Date: May 13, 2010

(54) METHOD AND DEVICE FOR MEASURING PARAMETERS OF CARDIAC FUNCTION

(76) Inventor: Xuefeng Cheng, Waterloo (CA)

Correspondence Address: PATENTANWAELTE LICHTI + PARTNER GBR, POSTFACH 41 07 60, D-76207, KARLSRUHE, DE

(21) Appl. No.: 12/449,149

(22) PCT Filed: Jan. 22, 2008
(86) PCT No.: PCT/EP2008/000444

§ 371 Date: Sep. 10, 2009

(30) Foreign Application Priority Data
Jan. 26, 2007 (DE) 10 2007 003 931.1

(51) Int. Cl. G01N 29/04

(52) U.S. Cl. 73/588

(57) ABSTRACT

A full tube is closed in a closing station of a tube filling machine by forming a welded joint, and the closed tube is then tested in terms of the tightness thereof. In order to do so, sound wave energy is introduced into the welded joint, and the sound wave that penetrates the welded joint is detected and is compared with a reference sound wave. The tube is classified as faulty if the detected sound wave deviates from the reference sound wave by more than a predetermined measure.

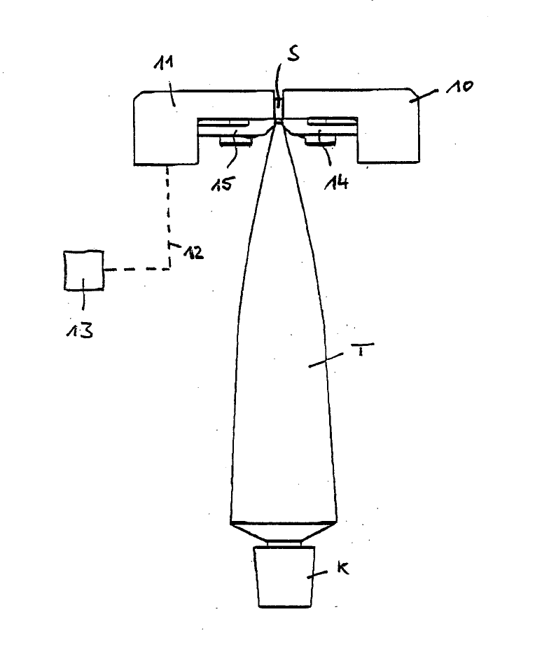

The invention relates to a method for testing the tightness of a full tube in a tube filling machine, wherein the full tube is closed in a closing station of a tube filling machine by forming a welded joint and the closed tube is then tested in terms of the tightness thereof. The invention also relates to an apparatus for testing the tightness of a welded joint of a full tube in a tube filling machine.

A tube filling machine with a usual structure has an endlessly circulating conveying device that carries a plurality of holders into each of which one tube is inserted by its head or cap section, wherein the tube in the holder passes through the individual workstations of the tube filling machine. In a filling station, a usually liquid or paste product can be filled into the tube, which is open at the top, by means of a filling nozzle. Then the filled, but still open tube is fed to a closing station, in which the tube is welded at its upper end facing away from the head or cap region. For this purpose, the upper edge region of the tube wall, which consists of plastic or an aluminum-plastic laminate, is heated until at least partially melted and then pressed together by jaws that move toward each other, wherein the molten material of the tube wall is joined to form a single-piece welded joint extending substantially perpendicular to the longitudinal extension of the tube.

After passing through the closing station, a sampling inspection is usually performed on individual tubes to ascertain whether the tube is closed tightly by the welded joint. A known method for testing the tightness of the tube is to exert mechanical pressure on the outside of the closed tube, that is, to squeeze the tube, and to observe whether the product exits the tube or whether the internal pressure of the tube is reduced. Alternatively, a further known method is to place the filled closed tube in an evacuated chamber and observe whether the internal pressure of the tube inflates it or whether the tube retains its shape, wherein it may be assumed in the latter case that a welded joint is defective.

Yet a further known method is to take a tube out of the production process in order to test it for tightness, to open the cap, and to apply a high internal pressure to the tube inside a special vessel until it bursts. Whether or not the tube was tight can be ascertained by the progression of the pressure and the limit pressure.

All these inspection methods are very complex and time-consuming and can therefore only be performed on very few tubes out of a production batch. This means that if a defective welded joint is detected, the entire production batch has to be removed as defective although information has only been obtained about the tightness or untightness of a single tube. As a result, tubes are frequently classified as faulty although they are properly closed.

The object of the invention is to provide a method for testing the tightness of a full tube in a tube filling machine that can be simply integrated into the filling process of the tube filling machine in such a way that a plurality of tubes can be inspected. Moreover, an apparatus is to be provided with which the method can be performed in a simple manner.

With respect to the method, the task is achieved with the features of claim 1. Therein sound wave energy is introduced into the welded joint of the closed tube to test the tightness and the sound wave that penetrates the welded joint is detected and is compared with a reference sound wave and the tube is classified as faulty if the detected sound wave of the welded joint deviates from the reference sound wave by more than a predetermined amount. In the inventive method, the welded joint is therefore inspected by sonic penetration. At the boundary surfaces in the structure of the welded joint, the sound intensity is weakened by scattering and reflection, which can be recognized by sensing the sound wave or wave pattern. Such boundary surfaces can arise, for example, due to defective welding parameters or due to soiling in the region of the welded joint.

The sound wave energy is introduced into the welded joint by means of a sound emitter that is preferably brought into contact with the welded joint over at least approximately the entire length thereof.

On the side of the welded joint facing away from the sound emitter, a sound receiver is disposed that is also brought into contact with the welded joint over at least approximately the entire length so that the welded joint is disposed between the sound emitter and the sound receiver and preferably clamped perpendicularly to its longitudinal extension. However, it is also possible to dispose the sound emitter and the sound receiver on the same side of the welded joint.

The sound frequencies introduced into the welded joint by means of sound emitters are preferably in the range >20 kHz, that is, in the ultrasonic range.

The sound receiver receives the sound energy, that is, a sound pattern, transmitted or reflected by the welded joint via the surface of the latter and emits corresponding signals to an evaluation unit, in which the detected sound pattern is compared with the reference sound pattern. If it is ascertained in the evaluation unit that the detected sound pattern deviates from the stored reference sound pattern by more than a predetermined amount, it is assumed that these deviations are caused by disturbances in the structure of the welded joint and that therefore the welded joint is not homogeneous. The tube under consideration is classified as faulty and removed from the production process.

It has proven advantageous if the tightness inspection is not performed immediately after the welding or closing operation but if the welded joint is initially cooled before the tightness inspection. This can be done using cooling devices with which the temperature of the welded joint can be lowered by a predefined measure, or by natural cooling.

The tightness inspection can be performed in a separate test station downstream of the closing station. In a preferred embodiment of the invention, however, the tightness inspection is performed directly in the closing station. In one possible embodiment of the invention, the sound emitter and the sound receiver can each be integrated into one of the jaws of the closing station, with which the softened wall regions of the tube are pressed together and welded.

With respect to the apparatus, the task is achieved by a sound emitter, by means of which sound wave energy can be introduced into the welded joint, and a sound receiver, by means of which the sound wave can be detected after passing through the welded joint and that is connected to an evaluation unit. The sound emitter preferably generates sound frequencies in the range >20 kHz, that is, in the ultrasonic range.

The sound emitter and the sound receiver can each be brought into contact with the entire length of the welded joint and are disposed on opposite longitudinal sides of the welded joint, so that these are disposed and, in particular, clamped between the sound emitter and the sound receiver. However, it is also possible to dispose the sound emitter and the sound receiver on the same side of the welded joint.

The sound emitter and the sound receiver can be disposed in a separate test station downstream of the closing station. However, the sound emitter and the sound receiver are preferably disposed in the closing station of the tube filling machine and, in particular, integrated into the jaws of the closing station.

Further details and characteristics of this invention can be taken from the following description of an embodiment, wherein the only FIGURE shows a side view of a tube during tightness inspection.

The FIGURE shows a tube T located in the closing station of a tube filling machine, whose head or cap section K is pointing downward. The tube T has been filled with a product in a filling station upstream in the production process and then brought into the closing station in the filled condition but with the upper end still open. In the closing station, the wall of the tube T is heated at the top in the usual way, until it is at least partially melted, whereupon two jaws 10 and 11 disposed diametrically to the tube T on opposite sides of the tube T, move together and clamp the tube between them, which squeezes the molten plastic material of the tube T to weld and close the upper end of the tube by forming a welded joint S.

Cooling units that can reduce the temperature of the welded joint S by a predetermined amount in a short time are integrated into the jaws 10 and 11 in a way that is not depicted.

Moreover, a sound emitter 14 is integrated into one of the jaws 10, while a sound receiver 15 is integrated into the other jaw 11 and connected via a cable 12 to an evaluation unit 13. The sound emitter 14 applies an ultrasound wave to the welded joint S over its entire length, that is, a predetermined sound pattern, which penetrates the welded joint S transversely with respect to its longitudinal extension. The sound receiver 15 receives the sound waves that have passed through the welded joint S and generates signals representing the ultrasonic pattern over the length of the welded joint S and forwards these to the evaluation unit.

If the welded joint S has a locally inhomogeneous structure due to inclusions, impurities, or cracks, the sound wave received by the sound receiver 15 will deviate from a defined target or reference sound pattern, which is ascertained by the evaluation unit 13. If the deviation is above a predetermined limit value, the welded joint S is classified as faulty and the tube T is removed from the production process.

1-8. (canceled)

9. A method for testing a tightness of a full tube in a tube filling machine, wherein the full tube is closed in a closing station by forming a welded joint and the closed tube is then tested with respect to the tightness thereof, the method comprising the steps of:
a) bringing a sound emitter into contact with the welded joint along a substantially entire length thereof;
b) disposing a sound receiver on a side of the welded joint facing away from the sound emitter to contact the welded joint substantially over an entire length thereof;
c) introducing sound wave energy into the welded joint using the sound emitter;
d) detecting a sound wave that penetrates the welded joint using the sound receiver;
e) comparing the sound wave detected in step d) to a reference sound wave; and
f) classifying the tube as faulty if the detected sound wave of the welded joint deviates from the reference sound wave by more than a predetermined amount.

10. The method of claim 1, wherein the sound receiver is connected to an evaluation unit in which the detected sound wave is compared with the reference sound wave.

11. The method of claim 9, wherein the sound frequencies introduced into the welded joint are in the range >20 kHz (ultrasound range).

12. The method of claim 9, wherein the welded joint is first cooled before the tightness is tested.

13. The method of claim 9, wherein the sound emitter and the sound receiver are each integrated in one jaw of the closing station.

14. An apparatus for testing a tightness of a full tube in a tube filling machine, wherein the full tube is closed in a closing station by forming a welded joint and the closed tube is then tested with respect to the tightness thereof, the apparatus comprising:
means for bringing a sound emitter into contact with the welded joint along a substantially entire length thereof;
means for disposing a sound receiver on a side of the welded joint facing away from the sound emitter to contact the welded joint substantially over an entire length thereof;
means for introducing sound wave energy into the welded joint using the sound emitter;
means for detecting a sound wave that penetrates the welded joint using the sound receiver;
means for comparing the sound wave detected to a reference sound wave; and
means for classifying the tube as faulty if the detected sound wave of the welded joint deviates from the reference sound wave by more than a predetermined amount.

15. The apparatus of claim 14, further comprising a closing station of the tube filling machine in which the sound emitter and sound receiver are disposed.

16. The apparatus of claim 15, wherein the sound emitter generates sound frequencies in the range >20 kHz (ultrasound range).

17. The apparatus of claim 15, wherein the sound emitter and the sound receiver are each integrated in one jaw of the closing station.
